(19) United States
(12) Patent Application Publication
(10) Pub. No.: US 2002/0075472 A1
(43) Pub. Date: Jun. 20, 2002

(54) Optical fiber ceilometer for meteorological cloud altitude sensing

(76) Inventor: Carvel E. Holton, Blacksburg, VA (US)

Correspondence Address: CANTOR COLBURN, LLP, 55 GRIFFIN ROAD SOUTH, BLOOMFIELD, CT, 06002

(21) Appl. No.: 09/957,931

(22) Filed: Sep. 20, 2001

Related U.S. Application Data
(60) Provisional application No. 60/234,484, filed on Sep. 22, 2000.

(51) Int. Cl. G01C 3/08

(52) U.S. Cl. 356/4.01

(57) ABSTRACT

An optical fiber based ceilometer for sensing cloud height is disclosed. In a first embodiment, the ceilometer comprises a transmitter based upon optical fibers transmitting an output signal to a target. The transmitter includes a radiation source generating the output signal at a prescribed wavelength or wavelengths. A first waveguide is receptive of the output signal and guides the output signal therealong. A receiver is receptive of a return signal wherein the return signal comprises the output signal reflected or backscattered from the target. In a second embodiment the ceilometer comprises a radiation source generating an output signal at a prescribed wavelength. An optical fiber transceiver is receptive of the output signal and transmits the output signal to a target, receiving thereby a return signal; wherein the return signal comprises the output signal reflected or backscattered off of the target. A sensor senses the return signal. An optical fiber or other multiplexer is receptive of the output signal, directs the output signal to the transceiver and is receptive of the return signal and directs the return signal to the sensor.

### CROSS-REFERENCE TO RELATED APPLICATIONS

This application claims the benefit of U.S. Provisional Application No. 60/234,484, filed on Sep. 22, 2000 which is incorporated herein by reference.

### GOVERNMENTAL INTEREST

The U.S. Government has a paid-up license in this invention and the right in limited circumstances to require the patent owner to license others on reasonable terms as provided for by the terms of contract number N-00014-00-M-0113 awarded by the U.S. Navy.

### BACKGROUND

A ceilometer is a specific and unique form of an optical lidar used to measure cloud stratification and atmospheric visibility conditions from the ground or airborne locations. A ceilometer's primary mission is to measure the range and intensity of a soft, distributed target and is therefore distinct from lidars which conventionally are associated with localized targets (including some velocimetry and most range-to-hard-target lidars). While a ceilometer can measure range to a hard target, the return from a ceilometer is a temporally distributed return and is therefore processed in the optical and temporal domain with different unique considerations. An example of the former may be sunlight rejection filters, not required on other systems and an example of the latter would be unique temporal filters suited to cloud temporal dynamics.

In remote cloud and visibility sensing applications, high power, free-space LIDAR (Light Detection and Ranging) systems have become the desired approach used for measuring atmospheric water vapor, condensate and visibility parameters in standoff or profiling scenarios. Application of such systems have mostly failed in volume deployments due, for example, to vibration/temperature sensitivity inherent in the lidar sources and optics; and the prohibitive cost and size of the available technology. However, applications in the meteorological sector require a standoff detection mechanism and which cannot be met by a single point, visibility measurement device. The standoff requirement in cloud sensing is imposed by the measurement scenario requiring accurate data from the free-atmosphere at ranges from just past ground structures to in excess of 2 km (low earth deck, typical), in order to insure accurate assessment of atmospheric near-earth boundary conditions. Numerous applications in meteorology and air transportation industries likewise have similar requirements of the composite system, including environmental requirements for extreme temperature conditions and ranges out to as much as 18-25 km. While most civil deployments do not operate in the composite conditions experienced by the military systems (including vibration and temperature extremes), they do experience many of the same conditions in reduced subsets. Most conventional, free-space lidars are, however, designed for considerably longer ranges (>10 km) and do not possess the deployment flexibility or environmental robustness required for these applications, even in lower powered units.

The latter factors and vibrational sensitivity, are primarily consequences of the complex, source/receiver optics required for high power, long range operation. The dominant environmental and vibrational interference mechanisms in the free-space optical systems conventionally used for ceilometers, is motion of the lidar optical elements themselves. This is particularly true in maintaining resonator alignment in the laser source itself. In this sense, the term “free-space optics” is used to designate optical systems which relay beams of light through the air between discrete optical elements as opposed to using light guides such as optical fibers and related components. Small motions in the complex optical path required by the free-space optics, can disrupt the precision alignment required for the detection of the returned lidar signal and as a result, introduce false signals or cause loss of signal entirely.

Related secondary problems associated with many free-space lidars are also numerous, including: excessive cost, poor short range performance(<300 m); inflexibility in deployment location; and substantial environmental cross-sensitivity in the large aperture optics. All these factors together have restricted the development and utilization of even compact low-power lidar systems based on free-space optical systems. A solution is required therefore that can address these problems. A compact and cost effective ceilometer system that can provide single point or profiling measurements at ranges from tens of meters out to a ranges between 5 and 10 kilometers has numerous application niches and markets.

Current ceilometers are based largely on laser sources and optical configurations historically associated with millijoule pulse output and wavelengths that are chosen for maximizing the backscatter coefficient (while minimizing the extinction coefficient). However, ceilometers have been proposed using all of the major atmospheric transmission windows. With the advent of solid state, diode-pumped doubled YAG lasers, most applications tend to use the 502-503 nm (green) portion of the wavelength spectrum. Green lidars are available in both large and micro-pulse pulse energy formats. Other implementations of lidars as ceilometers or as DIAL or wind shear lidars (which can be used for the ceilometer mission) are associated predominantly with Tm:YLF (2.01 μm), CO₂ (10.6 μm) and YAG/YLF (10.4-1.06 μm). Erbium systems have been largely unsuccessful, due to difficulties with the laser source.

For the most part however, the 500 nm green systems have been preferred in ceilometer usage due to the low extinction coefficient and high scattering coefficient at 500 nm. If however, the total extinction coefficient is examined as a function of wavelength, three things emerge. First, for normal air, the total extinction coefficient is dominated at 500 nm and 1.54 μm by the atmospheric haze and dust with only a small advantage belonging to the green wavelengths. The extinction coefficients are 0.12 km⁻¹ and 0.15 km⁻¹ respectively. Secondly, backscatter coefficient relative magnitudes at these wavelengths for cloud/fog droplets are 1.3 and 0.5 respectively, giving a signal advantage of approximately +4 dB to green wavelengths. For haze and nucleation particulates, the green backscatter advantage is +20 dB and alone explains the use of green lidar for particulate missions. However, the absorption by cloud/water vapor only increases the extinction coefficient by 0.05 km⁻¹ for 1.5 μm light in moderate fogs and scattering decreases the intensity of the green wavelengths in these media significantly. Consequently, for a 500 meter cloud deck, the signal advantage for a green source is +4.35 dB relative to a 1.54 μm IR source if only absorption is considered. This differential might translate into a 60 percent increase in range for the green sources, except that the green extinction due to scattering is 3 times larger to begin with. Hence, the green penetration into the cloud deck is not as high as the IR penetration and the green signal from the bottom of the cloud deck enjoys only a 4 dB or so advantage.

In short, the shorter wavelengths are substantially superior for detecting dust and haze, but have less advantage for detecting cloud decks and profiles. If sufficient power is available in a better source, certain wavelengths around 1.5 μm are clearly to be chosen for ceilometer functions.

### SUMMARY

A proposed solution, which has been demonstrated to yield compact ceilometer systems with added multiple degrees of design freedom (e.g., vibration compensation, multiple, in-band or out of band wavelength capability, simultaneous multi-wavelength operation, etc.), is the development of a ceilometer based on single mode or multi-mode optical fibers operating at wavelengths around 1.54 μm. Vibration, wind speed and range functions can be obtained from optical fiber ceilometers operating at 1.5 μm at ranges from several meters to in excess of hundreds of meters. The optical path in such a fiber ceilometer is constrained by the waveguide properties of the optical fibers utilized and hence results in compact, flexible systems with considerably less alignment issues either in manufacture or operation. FIG. 1B illustrates a bistatic optical fiber ceilometer and FIG. 5 illustrates a monostatic optical fiber ceilometer for a single feed fiber and illumination axis. Both bi-static and monostatic designs can be considered for fiber optic ceilometer functions, as the primary drawback to any fiber lidar is the limiting aperture as constrained by the coupling from the telescope objective to the optical fiber. In the illustrated systems, standard telecommunications components and a single optical output lens (monostatic) are used to fabricate the fiber optic ceilometer along with the standard, broadband pulse receivers and digital analysis software associated with conventional lidar packages. Further, fiber ceilometer systems can be integrated with a wide range of other optical fiber meteorological sensors such as temperature, barometric pressure and humidity to form a complete meteorological suite. Fiber ceilometers may use non-linear mechanisms such as Raman shift, Second Harmonic conversion, degenerate mixing, conversion, etc. to effect direct conversion of the operating wavelength internal to the fiber network without loss of alignment or efficiency common to other ceilometer sources. Fiber ceilometers may use multiple wavelengths simultaneously or in controlled sequence to achieve the primary cloud profiling task or secondary functions. To date little actual work has been done in this area, primarily because the meteorological community is not familiar with optical fiber sensors and systems.

Exploitation of fiber ceilometers to date has also been limited primarily by the availability of coherent laser source power. The availability of cost effective, fiber components from the telecommunications industry, including the recent commercial availability of 1-10⁺ W (CW)/10 kW (pulse) fiber amplifiers such as Erbium Doped Fiber Amplifiers (EDFAs), enables the design of very compact, cost effective fiber optic ceilometers at wavelengths around 1.54 μm with sufficient range for effective utilization. These sources are capable of generating a wide range of pulse waveforms in pulse energies from microjoules to millijoules. In particular, microjoule, fiber sources have the capability to eliminate deficiencies such as axial misalignment and vibration/temperature sensitivity, which are inherent in the sources of larger free-space ceilometers, while possessing sufficient energy to operate over ranges from several meters to several kilometers. This is particularly true for bi-static, large aperture designs. Also, EDFA sources are wavelength stable (stability determined by the master oscillator laser when used in a MOPA configuration), alignment stable and thermally stable to a high degree. The proposed ceilometer designs would validate the application and costs of fiber designs relative to the near cloud field meteorological sensing scenarios associated with general meteorological measurements. Such a system would naturally progress to the development of suitable ceilometers for a larger commercial market than that associated with free-space ceilometers and has the capability of expanding the sensing package into a wider range of meteorological sensors. As the cost of fiber telecommunications components continues to decrease, the performance advantages of fiber ceilometer will be utilized in a wide spectrum of meteorological applications offering substantial benefit to users.

Generally, fiber ceilometers are relatively low powered by comparison to free-space ceilometers but are considerably smaller, lower in cost and can achieve ranges suited to local atmospheric monitoring with 0.1 to 1+ watt EDFA sources. However, EDFA sources are continuing to emerge with increasing power output which will enable longer range ceilometer designs. Fiber ceilometers can be operated in monostatic or bistatic modes, achieve range functions in CW/FM/pulse modulation formats and use direct or coherent detection, with polarization preserving or non-polarization preserving fiber. For coherent fiber ceilometers the heterodyne efficiency is high as compared to a free-space ceilometer. In the fiber ceilometer schematic shown in FIG. 5, the local oscillator signal is taken from the end of the fiber and is matched to the returning signal in polarization and mode. This results in a heterodyne efficiency of 1.0 as opposed to the 0.1-0.5 typical of free-space ceilometer configurations. Normally, the local oscillator signal is not taken from this position in the fiber network, as the amplitude of the signal is difficult to control or optimize due to the limited range over which the reflectivity can be controlled at the end of the fiber. Instead, the local oscillator signal is usually controlled by another coupling element inserted into the network and polarization effects are accommodated with polarization maintaining fiber or the dynamic range of the signal processing and detection electronics.

Again, as noted, fiber ceilometer systems can be also be integrated with a wide range of other optical fiber meteorological sensors such as temperature, barometric pressure and humidity to form a complete meteorological suite. However, expansion of the technology has been constrained due to a lack of coherent source power and knowledge within the user community. Development of fiber lidars has been hit or miss as a result and often misdirected to solving other problems. The proposed ceilometer has the simplicity, and hence the capability, of building a fiber system based on a solid progressive path and addressing technical issues appropriate specifically to the shorter range ceilometer applications.

A fiber ceilometer can also be configured such that the optical fiber path can allow location of the output optic(s) to be physically remote from the supporting photonics. This allows ceilometer deployment configurations not technically feasible with a free-space device, including placing the supporting photonics in vibrationally and electromagnetic interference (EMI) isolated areas remote from the sensor's optical output. Again, as noted, the ceilometer may also be fabricated to use one or more wavelengths, including widely disparate wavelengths to achieve enhanced functionality in the basic measurement function or ancillary functions. Such functionality is not easily achieved in the typical free-spaced ceilometer. Also, fiberceilometers have considerably higher EMI integrity than free-space ceilometers by virtue of the total isolation inherent in the optical fiber waveguide with respect to standard power and radar EMI sources. Having said the above, it should be noted that the optical power available from the commercially available EDFA sources is currently sufficient for ceilometer functions with moderately large apertures. This forces the near term designs to be bi-static and the receiver functions to be directly imaged, not fiber coupled. As source powers increase in the commercial marketplace however, all of the advantages of monostatic systems will be come available.

### BRIEF DESCRIPTION OF THE DRAWING

Referring now to the drawings wherein like elements are numbered alike in the several figures:

FIG. 1A is a schematic block diagram of a bistatic optical fiber ceilometer;

FIG. 1B is a schematic block diagram of a direct detection, bistatic optical fiber ceilometer with direct imaging to a detector;

FIG. 1C is a schematic block diagram of a direct detection, bistatic optical fiber ceilometer;

FIG. 1D is a schematic block diagram of a bistatic optical fiber ceilometer employing coherent signal detection;

FIG. 2A is a schematic block diagram of a monostatic optical fiber ceilometer;

FIG. 2B is a schematic block diagram of a direct detection, monostatic optical fiber ceilometer;

FIG. 2C is a schematic block diagram of a monostatic, optical fiber ceilometer with coherent detection wherein an offset homodyne mode is shown;

FIG. 3 is a schematic block diagram of a wavelength agile source for contrast ceilometer functions including differential-absorption lidar (DIAL);

FIG. 4 is a schematic block diagram of a spectrally combined source for higher power operation of an optical fiber ceilometer;

FIG. 5 is a schematic block diagram of a monostatic optical fiber Lidar;

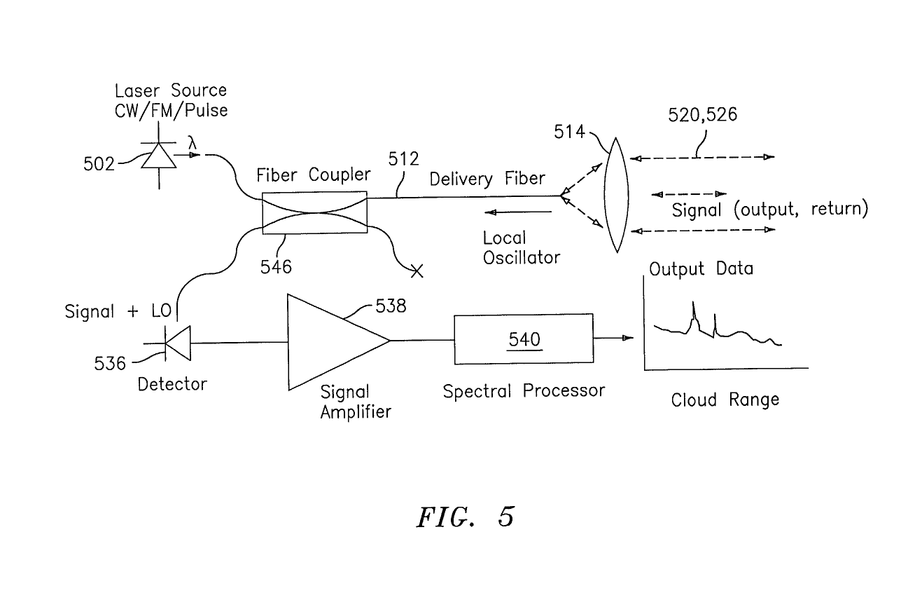

FIG. 6 is diagrammatic representation of a Cassegrainian telescope;

FIG. 7 is a schematic block diagram of a bistatic coherent ceilometer;

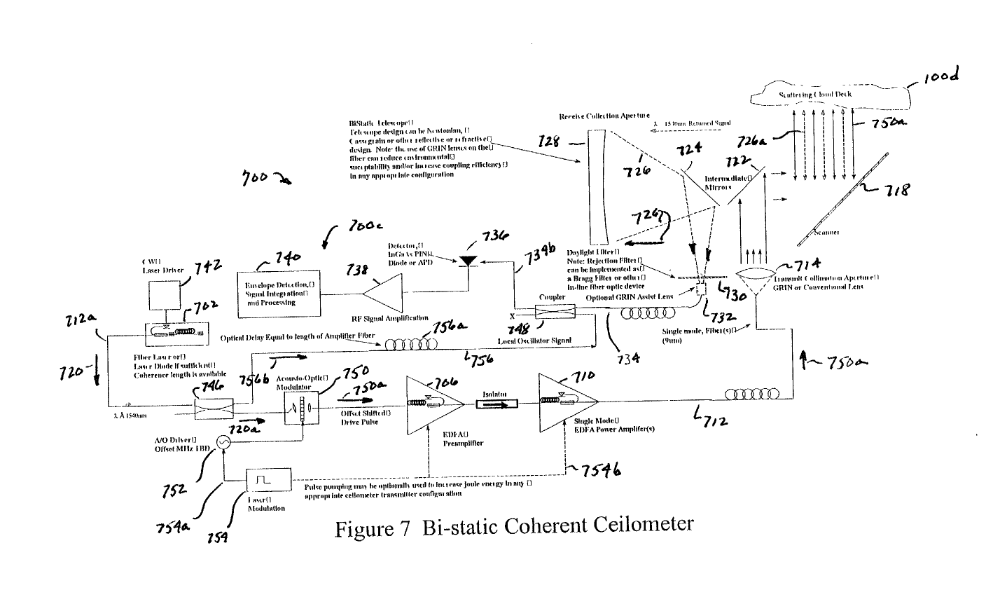

FIG. 8 is a schematic block diagram of a monostatic coherent ceilometer; and

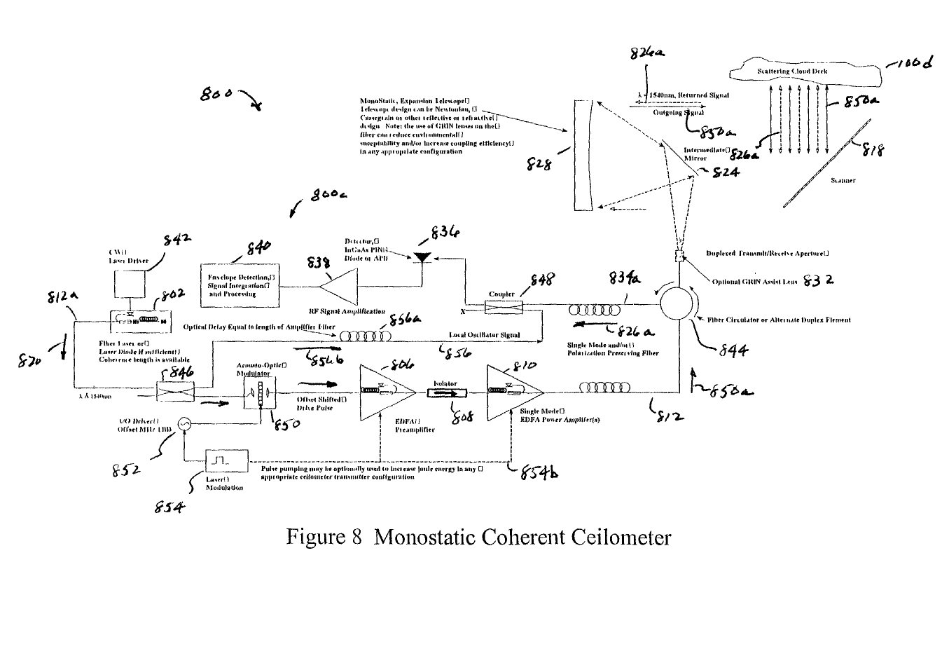

FIG. 9 is a schematic block diagram of a ceilometer with a pulse tone laser driver.

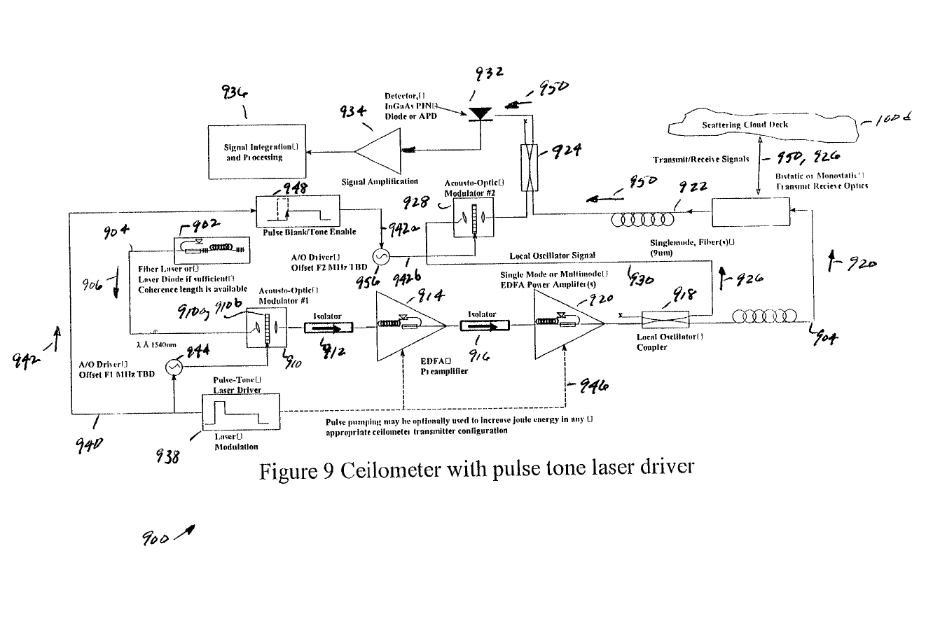

### DESCRIPTION OF THE INVENTION

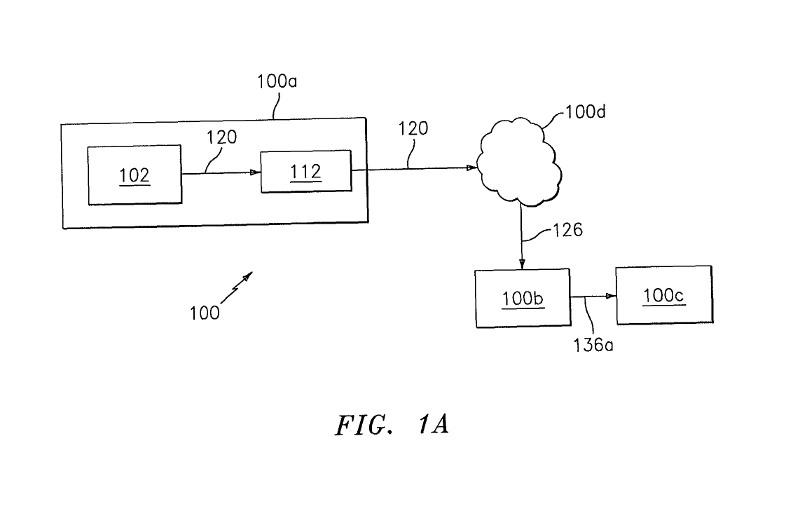

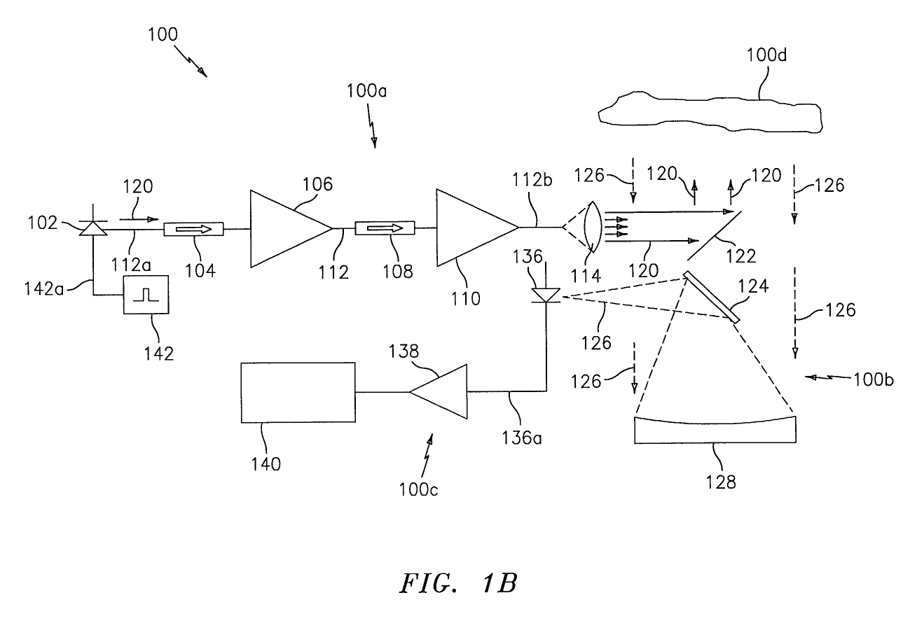

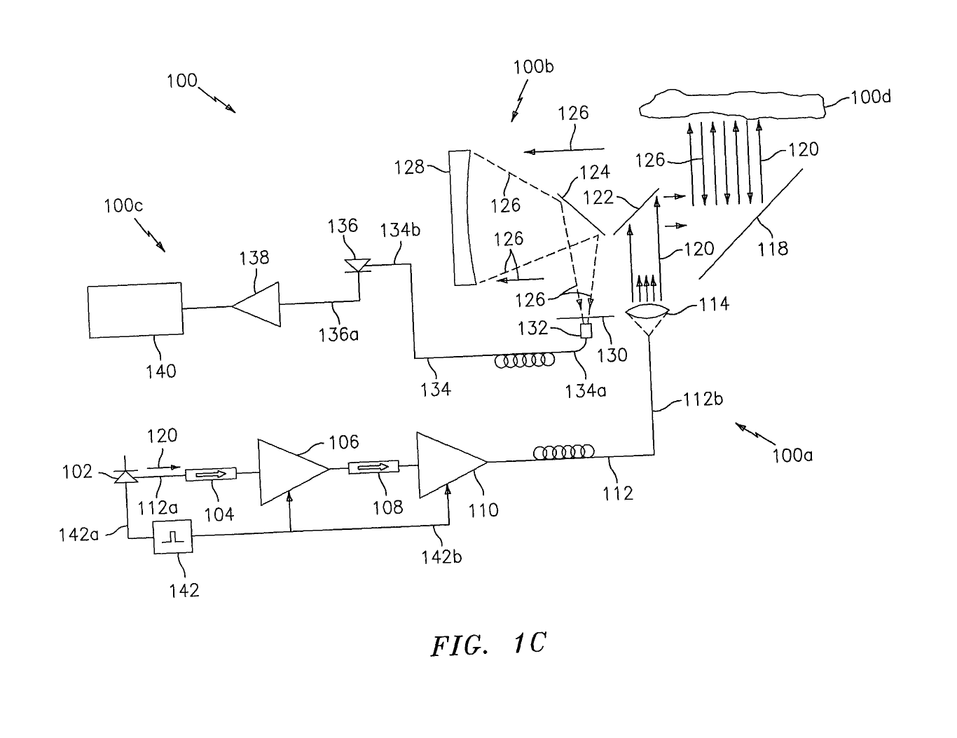

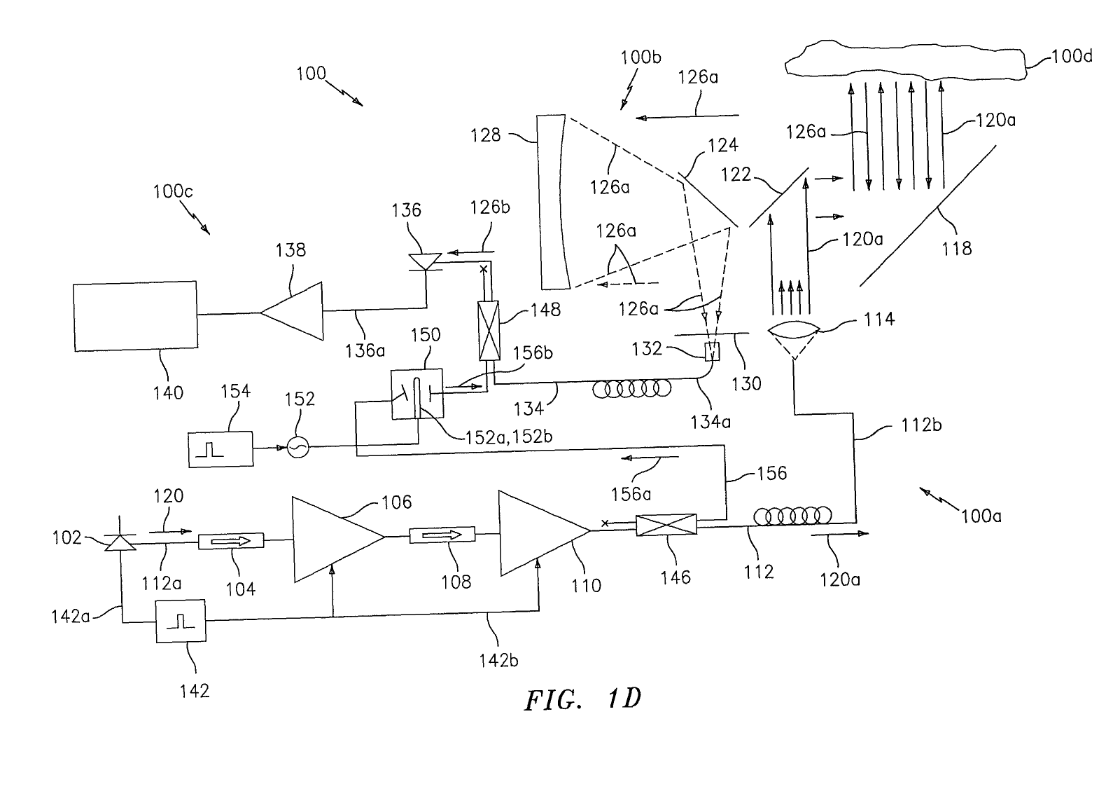

Referring to FIG. 1A, a schematic block diagram of a bistatic optical fiber ceilometer is shown generally at 100. The bistatic optical fiber ceilometer 100 comprises a transmitter 100a which transmits an output signal 120 to a target 100d. The target 100d may include for example an atmospheric cloud bank. The transmitter 100a includes a radiation source 102 which generates the output signal 120 at a prescribed wavelength λ. A waveguide 112 is receptive of the output signal 120 and guides the output signal 120 therealong. A receiver 100b receives a return signal 126 and provides as output a detected signal 136a. The return signal 126 comprises the output signal 120 reflected or backscattered from the target 100d. A processing unit 100c is receptive of the detected signal 136a for signal integration and signal processing.

Referring to FIG. 1B, in a first embodiment of the bistatic optical fiber ceilometer 100, the transmitter 100a includes a source of coherent radiation such as a laser (or lasers) 102 which generates the output signal 120 at a prescribed wavelength(or wavelengths), λ. The prescribed wavelength is suitable for transmission over an optical network and may have, for example, a wavelength of about 1540 nm. The waveguide 112 comprises a channel waveguide or a single mode or multimode, large core, optical fiber, either polarization preserving or non-polarization preserving. The optical fiber 112 includes an input terminus 112a, positioned near the laser 102 and is receptive of the output signal 120. A preamplifier 106, positioned near the input terminus 112a of the optical fiber 112 amplifies the output signal 120 generated by the laser 102. The optical fiber 112 also includes a first isolator 104 positioned between the laser 102 and the preamplifier 106 for reducing backreflected signals from the preamplifier 106. The optical fiber further comprises a power amplifier 110 for further amplifying the output signal 120 prior to the launch of the output signal 120 to the target 100d. The optical fiber 112 also includes a second isolator 108 positioned between the preamplifier 106 and the power amplifier 110 for reducing backreflected signals from the power amplifier 110. It will be understood that the optical fiber 112 may also include one or more line amplifiers (not shown) and isolators (not shown) for amplifying the output signal 120, and reducing back reflected signals thereof, as the output signal 120 is guided along the optical fiber 112. The preamplifier 106, the power amplifier 110 and the line amplifiers are rare earth doped fiber amplifiers such as Erbium³⁺ doped fiber amplifiers, Neodymium, Yterbium or Praseodymium doped fiber amplifiers.

Continuing in FIG. 1B, a controller 142 controls the laser 102 in a pulsed or continuous wave mode of operation. Also in FIG. 1B, positioned near an output terminus 112b of the optical fiber 112, is a lens 114, such as a conventional lens or a graded index (GRIN) lens, which shapes the output signal (or beam) 120 as the output signal 120 exits the optical fiber 112 and is launched to the target 10d. Such shaping includes for example collimating or focusing the output signal 120.

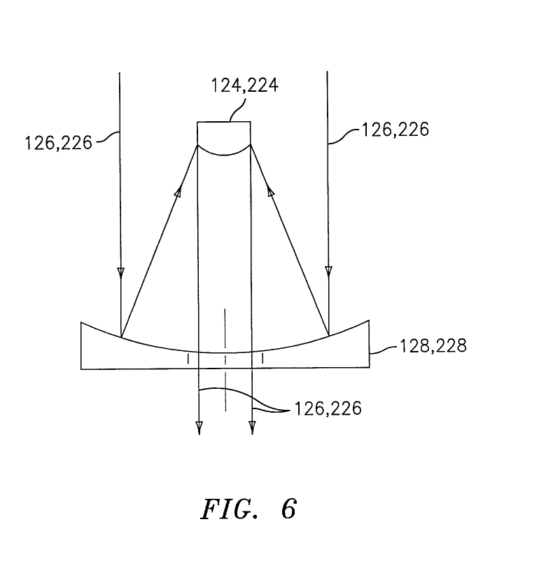

Still further in FIG. 1B, the output signal 120 departs the optical fiber 112 and is directed to the target 100d either directly or by redirection off of a reflector 122 such as a mirror. The output signal 120 encounters the target 100d and is reflected or backscattered therefrom as a return signal 126. The return signal 126 is received by the receiver 100b comprising a sensor 136 which detects the return signal 126 and a collection aperture 128, 124 which collects the return signal 126 and directs the return signal 126 to the sensor 136. The collection aperture 128, 124 comprises a Newtonian telescope or, as seen in FIG. 6, a Cassegrainian telescope or other optical apparatus of related function. The sensor 136 includes for example an InGaAs PIN diode or an avalanche photodiode (APD). The sensor 136 converts the return signal 126 into an electrical detected signal 136a for signal processing by the processing unit 100c. The processing unit 100c includes a signal amplifier 138 for amplifying the detected signal 136a.

Referring now to FIG. 1C, in a second embodiment of the bistatic optical fiber ceilometer 100, the controller 142 is synchronously in communication at 142a and 142b with the amplifiers 106, 110 and the laser 102 for pulse pumping to increase joule energy. Pulse pumping allows the drive 142a, 142b to the source 102 and the amplifiers 106, 110 to be synchronized in such a manner that spontaneous emission is suppressed in the amplifiers 106, 110 resulting in increased output energy from the amplifiers 106, 110. The output signal 120 is directed to a scanner 118 by a reflector 122 to allow the scanner 118 to direct the output signal 120 in such a manner as to obtain three dimensional images of the cloud structure 100d. If the scanner 118 is held stationary, the return signal 126 will provide only a two dimensional profile of the cloud structure 100d. In FIG. 1C, the receiver 100b further comprises a second waveguide 134 having an input terminus 134a and an output terminus 134b. The second waveguide 134 is receptive of the return signal 126 from the collection aperture 128, 124 at the input terminus 134a and guides the return signal 126 to the sensor 136. The second waveguide 134 comprises a channel waveguide or a single or multi-mode, large core, optical fiber polarization preserving or non-polarization preserving. In FIG. 1C, the receiver 100b further comprises a second lens 132 which focuses the return signal 126 onto the input terminus 134a of the second waveguide 134. The second lens 132 may be for example a conventional lens or a GRIN lens. The sensor 136 is positioned near the exit terminus 134b of the second waveguide 134 and is receptive of the guided return signal 126. As described above, the sensor 136 converts the return signal 126 into an electrical detected signal 136a for signal processing by the processing unit 100c. The processing unit 100c includes a signal amplifier 138 for amplifying the detected signal 136a. In FIG. 1C, the receiver 100b further comprises a filter 130 which filters out background radiation. A rejection filter 130 can be implemented as an optical fiber Bragg filter or other in-line fiber optic device in the second waveguide 134.

Referring now to FIG. 1D, in a third embodiment of the bistatic optical fiber ceilometer 100, waveguide 112 includes a first coupling device 146 receptive of the output signal 120 and operative to partition the output signal 120 into a local oscillator signal 156a carried over waveguide 156, and a partitioned output signal 120a carried over waveguide 112. Waveguide 156 comprises a modulator 150 which modulates the local oscillator signal 156a resulting in an offset local oscillator signal 156b. The frequency of the local oscillator signal 156a is offset by the frequency of the modulator 150 such that

ω_{offset}=ωₗₒₛ±ω_{mod}, (1)

where ω_{offset} is the frequency of the offset local oscillator signal 156b, ωₗₒₛ is the frequency of the local oscillator signal 156a and ω_{mod} is the frequency of the modulator 150. The modulator 150 comprises an acousto-optic modulator (e.g. Bragg cell) having a piezoelectric transducer 152a and a signal generator 152, 154 for establishing a moving refractive index grating in a crystal 152b by the elasto-optic effect as is well known in the art. The modulator 150 may also comprise an acousto-optic fiber frequency shifter. Other fiber frequency shifters that may be suitable as a modulator include birefringent fiber frequency shifters, two-mode fiber frequency shifters or serrodyne fiber frequency shifters as are well known in the art.

As in FIG. 1C, in FIG. 1D, the partitioned output signal 120a is guided by waveguide 112 to the lens 114 and thence to the target 100d via the receiver 100b. The partitioned output signal 120a encounters the target 100d and is reflected or backscattered therefrom to the receiver 100b return signal 126a. Waveguide 134, receptive of the return signal 126a, includes a second coupler 148 which combines the offset local oscillator signal 156b and the return signal 126a. The combined signal 126b is guided by waveguide 134 to sensor 136. The sensor 136 converts the combined signal 126b into an electrical signal 136a for envelope detection, frequency analysis, signal integration and temporal processing by the processing unit 100c.

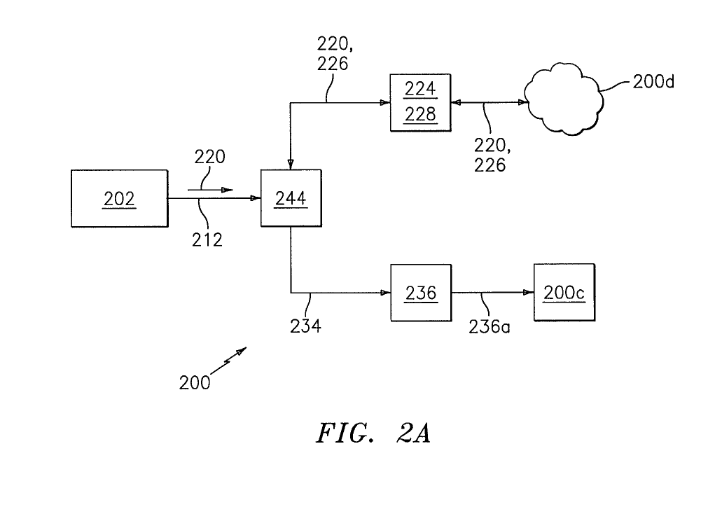

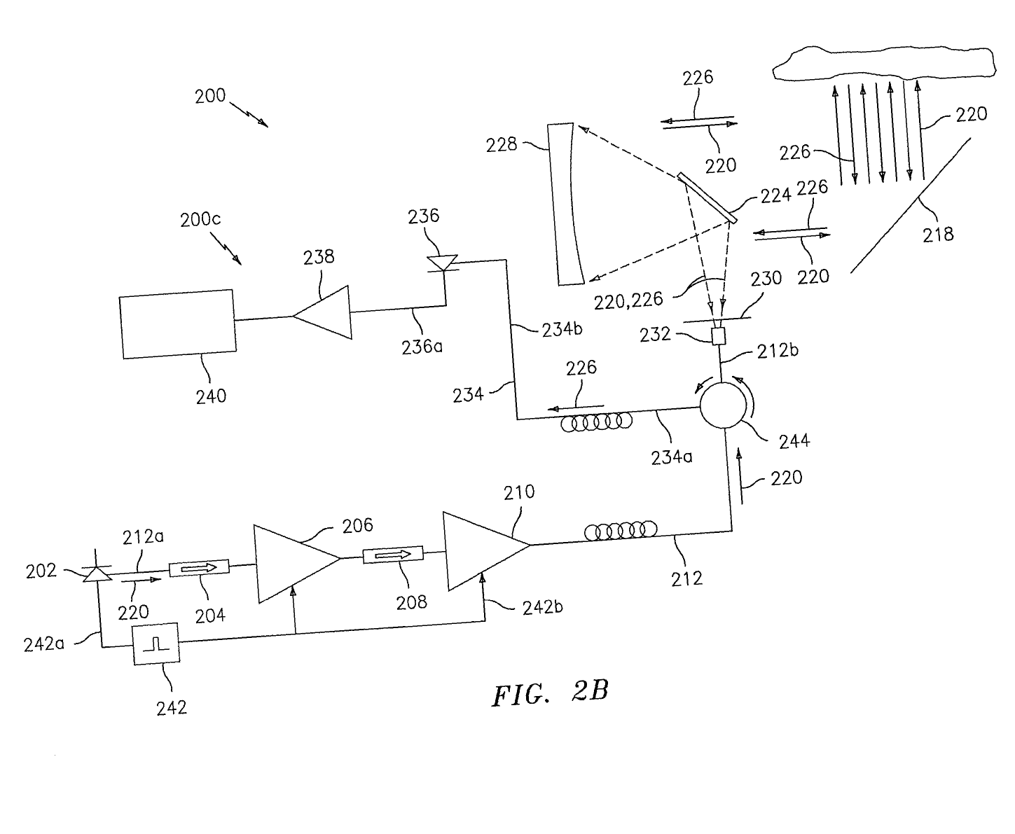

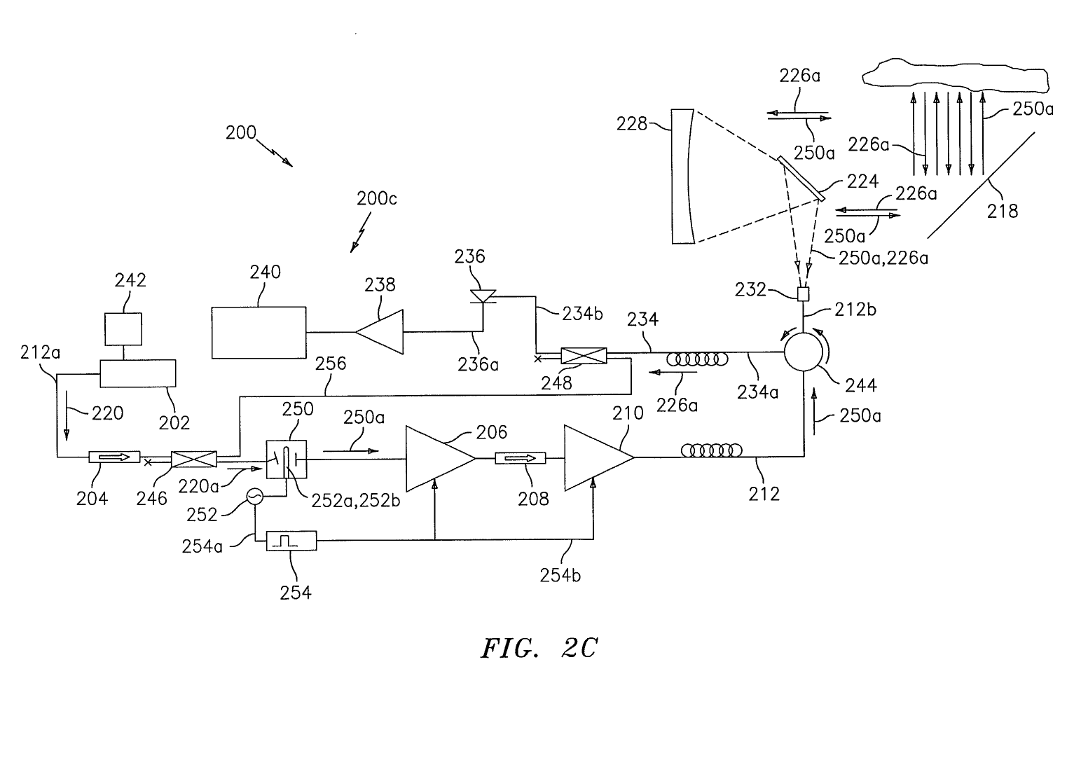

Referring now to FIG. 2A, a schematic block diagram of a monostatic optical fiber ceilometer is shown generally at 200. The monostatic optical fiber ceilometer 200 comprises a radiation source 202 which generates an output signal 220. A first waveguide 212 is receptive of the output signal 220 to guide the output signal to a multiplexing device 244. The multiplexing device 244 directs the output signal 220 to a transceiver 224, 228 from which the output signal 220 is launched to a target 200d. The output signal 220 encounters the target and is reflected or backscattered therefrom as a return signal 226. The return signal 226 is received by the transceiver 224, 228 from which the return signal 226 is directed to the multiplexing device 244. A second waveguide 234 is receptive of the return signal 226 to guide the return signal 226 to a sensor 236. The sensor 236 converts the return signal 226 to an electrical detected signal 236a for processing by a signal processing unit 200c.

Referring to FIG. 2B, in a first embodiment of the monostatic optical fiber ceilometer 200, the radiation source 202 includes a source of coherent radiation such as a laser (or lasers) for generating the output signal 220 at a prescribed wavelength (or wavelengths), λ. The prescribed wavelength is suitable for transmission over an optical network and may have for example a wavelength of about 1540 nm. The laser 202 may include for example a laser diode or a fiber laser or combination thereof. The first waveguide 212 comprises a channel waveguide or a single mode or multimode, large core, optical fiber, polarization preserving or non-polarization preserving. The optical fiber 212 includes an input terminus 212a, positioned near the laser 202, and a preamplifier 206, positioned near the input terminus 212a of the optical fiber 212 for amplifying the output signal 220 generated by the laser 202. The optical fiber 212 also includes a first isolator 204 positioned between the laser 202 and the preamplifier 206 for reducing backreflected signals from the preamplifier 206. The optical fiber 212 further comprises a power amplifier 210 for further amplifying the output signal 220 prior to the launch of the output signal 220 to the target 200d. The optical fiber 212 also includes a second isolator 208 positioned between the preamplifier 206 and the power amplifier 210 for reducing backreflected signals from the power amplifier 210. It will be understood that the optical fiber 212 may also include at least one line amplifier (not shown) and isolator (not shown) for amplifying, and reducing backreflected signals of, the output signal 220 as the output signal 220 is guided along the optical fiber 212. It will also be understood that the fiber 212 may be implemented in such a manner as to allow fiber 212 to function as laser, an amplifier or a wavelength converter. The preamplifier 206, the power amplifier 210 and the line amplifiers are rare earth doped fiber amplifiers such as Erbium³⁺ doped fiber amplifers or Praseodymium doped fiber amplifiers. A controller 242 controls the laser 202 at 242a in a pulsed or continuous wave mode of operation. The controller 242 may be synchronously in communication with the amplifiers 206, 210 at 242b and the laser 202 at 242a for pulse pumping to increase joule energy.

Continuing in FIG. 2B, positioned near an output terminus 212b of the optical fiber 212 the multiplexing device 244 comprises a circulator operative to direct the output signal 220 from the optical fiber 212 to the transceiver 224, 228 and direct the return signal 226 from the transceiver 224, 228 to the second waveguide 234. Further, a lens 232 is positioned near the output terminus 212b of the optical fiber 212 for expanding the output signal 220 to the transceiver 224, 228 and focusing the return signal 226 from the transceiver 224, 228 to the optical fiber 212. The output signal 220 departs the optical fiber and is directed to the target 200d via the transceiver 224, 228 and a scanner 218. The output signal 220 encounters the target 200d and is reflected or backscattered therefrom to the transceiver 224, 228 as the return signal 226. The transceiver 224, 228 comprises for example a Newtonian telescope or as seen in FIG. 6, a Cassegrainian telescope or other optical apparatus of related function. The return signal 226 is brought to focus at the optical fiber 212 from which it is directed to the input terminus 234a of the second waveguide 234 by the circulator 244. The second waveguide 234 is receptive of the return signal 226 from the circulator 244 and guides the return signal 226 to the sensor 236. The second waveguide 234 comprises a channel waveguide or a single or multimode, large core optical fiber, polarization preserving or non-polarization preserving. The sensor 236 is positioned near the exit terminus 234b of the second waveguide 234 and is receptive of the guided return signal 226. The sensor includes for example an InGaAs PIN diode or an avalanche photodiode (APD). The sensor 236 converts the guided return signal 226 into an electrical detected signal 236a for signal processing by the signal processing unit 200c. The processing unit 200c includes a signal amplifier 238 for amplifying the detected signal 236a. In FIG. 2B, a filter 230 filters out background radiation. A rejection filter can be implemented as a fiber Bragg filter or other in-line fiber optic device.

Referring now to FIG. 2C, in a second embodiment of the monostatic optical fiber ceilometer 200, the first waveguide 212 includes a first coupling device 246 receptive of the output signal 220 and operative to partition the output signal 220 into a local oscillator signal 256 and a partitioned output signal 220a. The first waveguide 212 further comprises a modulator 250 which modulates the partitioned output signal 220a resulting in a frequency offset output signal 250a. The frequency of the partitioned output signal 220a is offset by the frequency of the modulator 250 such that

ω_{offset}=ωₚₒₛ±ω_{mod}, (2)

where ω_{offset} is the frequency of the offset output signal 250a, ωₚₒₛ is the frequency of the partitioned output signal 220a and (Cmod is the frequency of the modulator 250. The modulator 250 comprises an acousto-optic modulator (e.g. Bragg cell) having a piezoelectric transducer 252a and a signal generator 252 for establishing a moving refractive index grating in a crystal 252b by the elasto-optic effect as is well known in the art. The modulator 250 may also comprise an acousto-optic fiber frequency shifter. Other fiber frequency shifters that may be suitable as a modulator include birefringent fiber frequency shifters, two-mode fiber frequency shifters or serrodyne fiber frequency shifters as are well known in the art. As in the first embodiment of the monostatic optical fiber ceilometer 200 seen in FIG. 2B, the offset output signal 250a is guided by the first waveguide 212 to the circulator 244 and directed to the target 200d via the transceiver 224, 228 and the scanner 218. The offset output signal 250a encounters the target 200d and is reflected or backscatterred therefrom to the transceiver 224, 228 as an offset return signal 226a. A second waveguide 234, receptive of the offset return signal from the circulator, includes a second coupler 248 which combines the local oscillator signal 256 with the offset return signal 226a. The combined signal 234c is guided by the second waveguide 234 to a sensor 236. The sensor 236 converts the combined signal 234c into an electrical signal 236a for envelope detection, frequency analysis, signal integration and temporal processing by the processing unit 200c. As best understood from FIG. 2C, the laser 202 may comprise a fiber laser or a laser diode, if there is enough coherence length available. A controller 242 controls the laser 202 at 242a in a pulsed or continuous wave mode of operation.

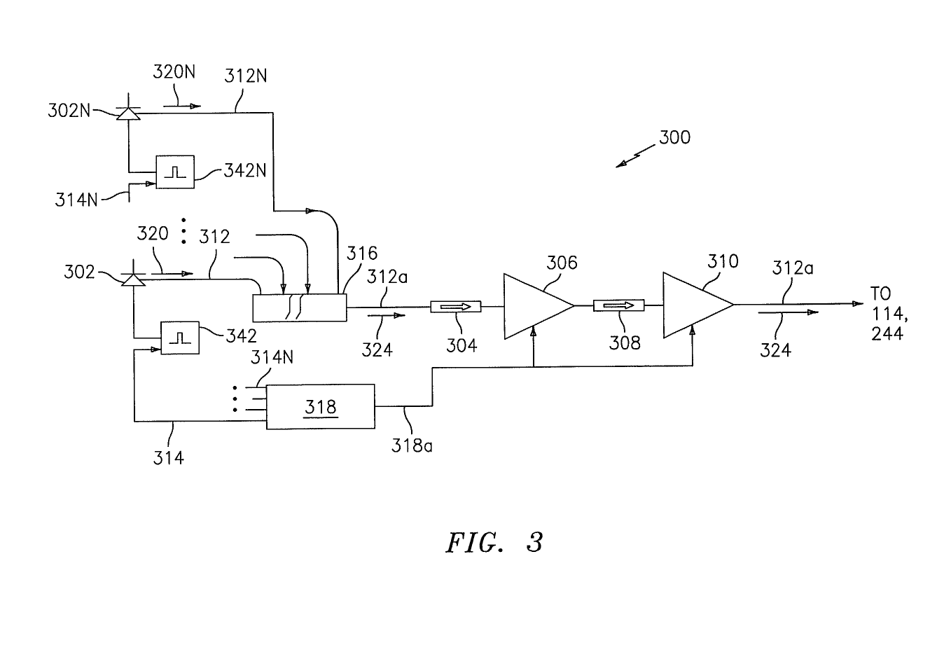

Referring now to FIG. 3, in a further embodiment of the bistatic and monostatic optical fiber ceilometers of FIGS. 1A-2C, the radiation source 102, 202 includes a plurality (e.g. N) of radiation sources 302, 302N. The N radiation sources 302, 302N are synchronously controlled at 314 and 314N by N corresponding controllers 342, 342N from a wavelength synchronization logic unit 318. Each of the N radiation sources 302, 302N provide N corresponding output signals 320, 320N, simultaneously or in a controlled sequence, having wavelengths of λ₁ through λ_{N}. Such wavelengths may include for example λ₁ of about 1540 nm through λ_{N} of about 1550 nm. A plurality of N waveguides 312, 312N are receptive of the N output signals 320, 320N at their respective input termini for guiding the N output signals 320, 320N to a combiner 316 such as a wavelength division multiplexing (WDM) combiner. The WDM combiner 316 provides as output a wavelength division multiplexed serial combined source power sequence of N output signals 324 to waveguide 312a. Waveguides 312, 312N, 312a may be a channel waveguide or a single mode or multimode large core optical fiber as described above and may include preamplifier 306, power amplifier 310, line amplifiers (not shown) and isolators 304, 308, all as described above. The amplifiers 306, 310 may also be subject to pulse pumping at 318a to increase the joule energy. Waveguide 312a guides the multiplexed output signals 320, 320N to the lens 114 of FIGS. 1B and 1C or to the circulator 244 of FIGS. 2B and 2C.

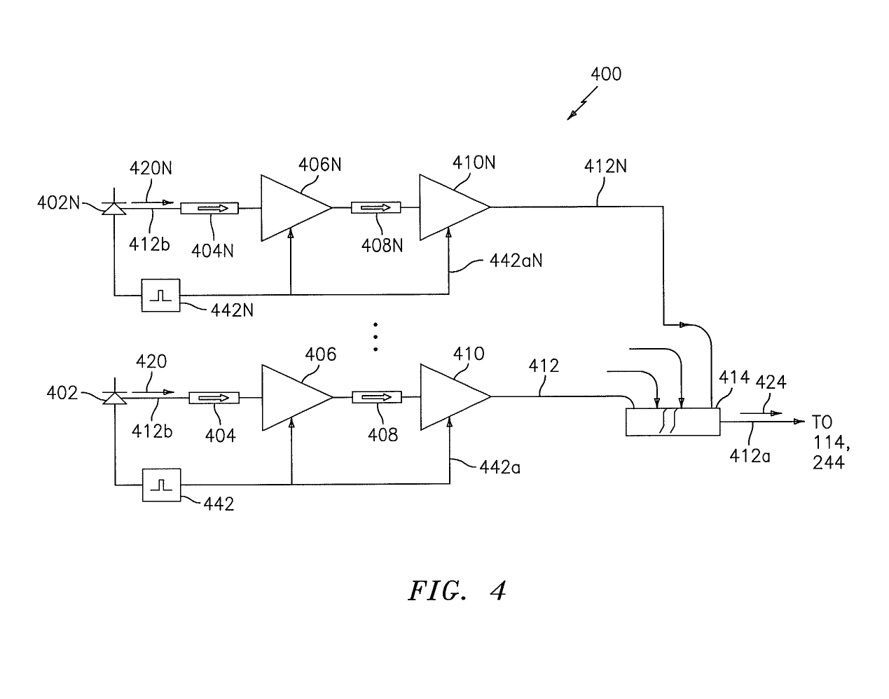

Referring now to FIG. 4, in a further embodiment of the bistatic and monostatic optical fiber ceilometers of FIGS. 1A-2C, the radiation source 102, 202 includes a plurality (e.g., N) of radiation sources 402, 402N. The N radiation sources 402, 402N are controlled by N corresponding controllers 442, 442N for controlling the N radiation sources 442, 442N in a pulsed or continuous wave mode of operation, simultaneously or in controlled sequence. The N radiation sources 402, 402N provide N output signals 420, 420N having wavelengths of λ₁ through λ_{N}. Such wavelengths may include for example λ₁ of about 1540 nm through N of about 1550 nm. A plurality of N waveguides 412, 412N are receptive of the N output signals 420, 420N at their input termini for guiding the N output signals 420, 420N to a combiner 414 such as a WDM combiner. The WDM combiner 414 provides as output a wavelength division multiplexed serial combined source power sequence of N output signals 424 to waveguide 412a. Waveguide 412a guides the N output signals to the lens 114 of FIGS. 1B and 1C or to the circulator 244 of FIGS. 2B and 2C. In FIG. 4, the N waveguides 412, 412N comprise a channel waveguide or a single mode or multimode, large core, optical fiber, polarization preserving or non-polarization preserving. By way of example, the optical fibers each include an input terminus 412b, positioned near the laser 402, and may include a preamplifier 406, positioned near the input terminus 412b of the optical fiber 412 for amplifying the output signal 420 generated by the laser 402. The optical fiber 412 also includes a first isolator 404 positioned between the laser 402 and the preamplifier 404 for reducing backreflected signals from the preamplifier 406. The optical fiber may further comprise a power amplifier 410 for further amplifying the output signal 420 prior to the launch of the output signal 420 to the target 200d. The optical fiber 412 also includes a second isolator 408 positioned between the preamplifier 406 and the power amplifier 410 for reducing backreflected signals from the power amplifier 410. It will be understood that the optical fiber may also include one or more line amplifiers (not shown) and isolators (not shown) for amplifying, and reducing backreflected signals of, the output signal 420 as the output signal 420 is guided along the optical fiber 412. The preamplifier 406, the power amplifier 410 and the line amplifiers may be rare earth doped fiber amplifiers such as Erbium³⁺ doped fiber amplifers, Neodymium, Yterbium or Praseodymium doped fiber amplifiers.

Thus, based upon the foregoing description, a monostatic and bistatic optical fiber based ceilometer is disclosed for sensing atmospheric cloud height. While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting the claims.

What is claimed is

1. A ceilometer for sensing cloud height, the ceilometer comprising:
a transmitter transmitting an output signal to a target, the transmitter including a radiation source generating the output signal at a prescribed wavelength;
a first waveguide receptive of the output signal guiding the output signal therealong; and
a receiver receptive of a return signal wherein the return signal comprises the output signal reflected or backscattered from the target.

2. The ceilometer as set forth in claim 1 wherein the waveguide comprises an optical fiber, a slab waveguide or a channel waveguide.

3. The ceilometer as set forth in claim 2 wherein the radiation source comprises a laser.

4. The ceilometer as set forth in claim 1 wherein the waveguide includes an amplifier amplifying the output signal.

5. The ceilometer as set forth in claim 1 wherein the transmitter further includes a controller controlling the radiation source in a continuous wave or pulsed mode of operation.

6. The ceilometer as set forth in claim 4 wherein the waveguide includes an isolator reducing signals backreflected from the amplifier.

7. The ceilometer as set forth in claim 4 wherein the amplifier comprises a rare earth doped amplifier.

8. The ceilometer as set forth in claim 7 wherein the rare earth doped amplifier comprises an Erbium doped amplifier.

9. The ceilometer as set forth in claim 1 wherein the transmitter further includes means, receptive of the output signal, for shaping the output signal.

10. The ceilometer as set forth in claim 1 wherein the transmitter further includes a reflector receptive of the output signal to direct the output signal to the target.

11. The ceilometer as set forth in claim 1 wherein the receiver comprises:
a sensor detecting the return signal; and
a collection aperture collecting the return signal and directing the return signal to the sensor.

12. The ceilometer as set forth in claim 11 wherein the collection aperture comprises a Newtonian telescope.

13. The ceilometer as set forth in claim 11 wherein the collection aperture comprises a Cassegrainian telescope.

14. The ceilometer as set forth in claim 9 wherein means for shaping the output signal comprises a collimating lens.

15. The ceilometer as set forth in claim 14 wherein the collimating lens comprises a graded index lens.

16. The ceilometer as set forth in claim 5 wherein the controller is in communication with the amplifier synchronously controlling thereby the amplifier with the radiation source.

17. The ceilometer as set forth in claim 11 wherein the sensor comprises a photodiode for generating a detected signal indicative of the return signal.

18. The ceilometer as set forth in claim 1 further comprising a processor in signal communication with the receiver for processing a signal indicative of the return signal.

19. The ceilometer as set forth in claim 11 wherein the receiver further comprises:
a second waveguide receptive of the return signal from the collection aperture for directing the return signal to the sensor; and
means for focusing the return signal from the collection aperture to the second waveguide.

20. The ceilometer as set forth in claim 11 wherein the receiver further comprises a filter filtering background radiation from the return signal.

21. A ceilometer for sensing cloud height, the ceilometer comprising:
a radiation source generating an output signal at a prescribed wavelength;
a transceiver receptive of the output signal transmitting the output signal to a target and receiving thereby a return signal wherein the return signal comprises the output signal reflected or backscattered off of the target;
a sensor sensing the return signal; and
a multiplexer receptive of the output signal directing the output signal to the transceiver and receptive of the return signal directing the return signal to the sensor.

22. The ceilometer as set forth in claim 21 further comprising a first waveguide guiding the output signal to the multiplexer.

23. The ceilometer as set forth in claim 21 further comprising a processor in signal communication with the transceiver for processing a signal indicative of the return signal.

24. The ceilometer as set forth in claim 22 wherein the first waveguide comprises an optical fiber, a slab waveguide or a channel waveguide.

25. The ceilometer as set forth in claim 21 wherein the radiation source comprises a laser.

26. The ceilometer as set forth in claim 22 wherein the first waveguide includes an amplifier amplifying the output signal.

27. The ceilometer as set forth in claim 26 wherein the amplifier comprises a rare earth doped amplifier.

28. The ceilometer as set forth in claim 27 wherein the rare earth doped amplifier comprises an Erbium doped amplifier.

29. The ceilometer as set forth in claim 26 wherein the first waveguide includes an isolator reducing signals backreflected from the amplifier.

30. The ceilometer as set forth in claim 26 further comprising a controller controlling the radiation source in a continuous wave or pulsed mode of operation.

31. The ceilometer as set forth in claim 30 wherein the controller is in communication with the amplifier synchronously controlling thereby the amplifier with the radiation source.

32. The ceilometer as set forth in claim 21 wherein the transceiver further comprises an transceiving aperture receptive of the output signal from the multiplexer directing thereby the output signal to the target and receptive of the return signal from the target directing thereby the return signal to the multiplexer.

33. The ceilometer as set forth in claim 32 wherein the transceiving aperture comprises a Newtonian telescope.

34. The ceilometer as set forth in claim 32 wherein the transceiving aperture comprises a Cassegrainian telescope.

35. The ceilometer as set forth in claim 32 wherein the transceiver further comprises means, receptive of the output signal and the return signal, for shaping the output signal and the return signal.

36. The ceilometer as set forth in claim 35 wherein means for shaping the output signal and the return signal comprises a lens.

37. The ceilometer as set forth in claim 36 wherein the lens comprises a graded index lens.

38. The ceilometer as set forth in claim 32 further comprising a filter filtering background radiation from the return signal.

39. The ceilometer as set forth in claim 21 further comprising a second waveguide guiding the return signal from the multiplexer to the sensor.

40. The ceilometer as set forth in claim 39 wherein the second waveguide comprises an optical fiber, a slab waveguide or a channel waveguide.

41. The ceilometer as set forth in claim 21 further comprising:
a first signal coupler for partitioning the output signal into a local oscillator signal and a partitioned output signal; and
a second coupler for combining the local oscillator signal with the return signal.

42. The ceilometer as set forth in claim 41 further comprising a modulator modulating the partitioned output signal.

43. The ceilometer as set forth in claim 42 wherein the modulator comprises an acousto-optic modulator.

44. The ceilometer as set forth in claim 43 further comprising an acousto-optic controller for driving the acousto-optic modulator at a prescribed frequency.

45. The ceilometer as set forth in claim 5 wherein the transmitter comprises:
a plurality of radiation sources, each radiation source generating a corresponding output signal at a separate wavelength;
a plurality of controllers controlling the plurality of radiation sources in a continuous wave or pulsed made operation; and
a wavelength combiner receptive of the corresponding output signals generating thereby a multiplexed signal.

46. The ceilometer as set forth in claim 45 further comprising:
a plurality of waveguides, each waveguide perceptive of a corresponding output signal from the plurality of radiation sources;
wherein the plurality of waveguides provide as output thereby the corresponding output signals to the wavelength combiner.

47. The ceilometer as set forth in claim 45 further comprising a wavelength synchronization logic unit in signal communication with the plurality of controllers for synchronizing the operation of the plurality of radiation sources.

48. The ceilometer as set forth in claim 47 wherein the wavelength synchronization logic unit is in signal communication with the amplifier for synchronizing the amplifier with the plurality of radiation sources.

49. The ceilometer as set forth in claim 45 wherein the first waveguide is receptive of the multiplexed signal.

50. The ceilometer as set forth in claim 30 wherein the transmitted comprises:
a plurality of radiation sources, each radiation source generating a corresponding output signal at a separate wavelength;
a plurality of controllers controlling the plurality of radiation sources in a continuous wave or pulsed made operation; and
a wavelength combiner receptive of the corresponding output signals generating thereby a multiplexed signal.

51. The ceilometer as set forth in claim 50 further comprising:
a plurality of waveguides, each waveguide perceptive of a corresponding output signal from the plurality of radiation sources;
wherein the plurality of waveguides provide as output thereby the corresponding output signals to the wavelength combiner.

52. The ceilometer as set forth in claim 50 further comprising a wavelength synchronization logic unit in signal communication with the plurality of controllers for synchronizing the operation of the plurality of radiation sources.

53. The ceilometer as set forth in claim 52 wherein the wavelength synchronization logic unit is in signal communication with the amplifier for synchronizing the amplifier with the plurality of radiation series.

54. The ceilometer as set forth in claim 50 wherein the first waveguide is receptive of the multiplexed signal.
